(19) United States
(12) Patent Application Publication
(10) Pub. No.: US 2017/0359225 A1
(43) Pub. Date: Dec. 14, 2017

(54) INFORMATION AGGREGATION METHOD AND APPARATUS AND SYSTEM

(71) Applicant: FUJITSU LIMITED, Kawasaki-shi (JP)

(72) Inventors: Xiaojing FAN, Beijing (CN); Hao Wang, Beijing (CN); Su Yi, Beijing (CN); Lefei Wang, Beijing (CN); Wenqian Xue, Beijing (CN); Ryuichi Matsukura, Kawasaki-shi (JP)

(73) Assignee: FUJITSU LIMITED, Kawasaki-shi (JP)

(21) Appl. No.: 15/606,329

(22) Filed: May 26, 2017

(30) Foreign Application Priority Data
Jun. 12, 2016 (CN) 201610409572.4

(51) Int. Cl. H04L 12/24; H04L 29/06; H04L 9/08

(52) U.S. Cl. CPC H04L 41/14; H04L 9/0838; H04L 41/06; H04L 63/0428

(57) ABSTRACT

Embodiments of this disclosure provide an information aggregation method and apparatus and a system. the method includes: a requestor generates an aggregation request, the aggregation request comprising a source address, a destination address, a requested target device, requested information, and a requested aggregation action; wherein, the source address is an address of the requestor, and the destination address is an address of a receiver, there existing a security relationship between the requestor and the receiver; the requestor encrypts the aggregation request according to the security relationship between the requester and the receiver; and the requestor transmits the encrypted aggregation request to the receiver, and records the aggregation request in a request list. With the embodiments of this disclosure, information may be aggregated between mutually trusted devices in a secure manner. Hence, a device may aggregate information for an untrusted device without security concern.

### TECHNICAL FIELD

This disclosure relates to the field of communication technologies, and in particular to an information aggregation method and apparatus and a system.

### BACKGROUND ART

The fault diagnosis system is necessary to guarantee a steady operation of the wide area network. The information aggregation is an effective fault diagnosis scheme. A lot of information is required in a reliable fault diagnosis process, like the operating state of network device, the performance condition of network media, etc. Hence, a lot of information needs to be aggregated among the network devices locating in different area, and the information exposes in the security risk in a large area.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

In order to solve the problems pointed in the background art, embodiments of this disclosure provide an information aggregation method and apparatus and a system. Using this method, the information can be aggregated in a security manner between trusted devices, and a device can aggregate information for an untrusted device without security concern.

According to a first aspect of the embodiments of this disclosure, there is provided an information aggregation method, applicable to a requestor for information in an information aggregation system, the method including:

an aggregation request is generated, the aggregation request including a source address, a destination address, a requested target device, requested information, and a requested aggregation action; wherein, the source address is an address of the requestor, and the destination address is an address of a receiver, there existing a security relationship between the requestor and the receiver;

the aggregation request is encrypted according to the security relationship between the requestor and the receiver; and

the encrypted aggregation request is transmitted to the receiver, and the aggregation request is recorded in a request list.

According to a second aspect of the embodiments of this disclosure, there is provided an information aggregation method, applicable to a receiver receiving an aggregation request in an information aggregation system, the method including:

an aggregation request is received;

the aggregation request is decrypted;

when the receiver is a target device of the aggregation request, requested information is prepared, an aggregation action indicated by the aggregation request is performed on the prepared information, and an aggregation reply is generated, the aggregation reply including a source address, a destination address, a requested target device, and prepared requested information; wherein, the source address is an address of the receiver, the destination address is an address of a device transmitting the aggregation request, and the requested target device is the receiver;

the aggregation reply is encrypted according to a security relationship between the receiver and the device transmitting the aggregation request; and

the encrypted aggregation reply is transmitted to the device transmitting the aggregation request.

According to a third aspect of the embodiments of this disclosure, there is provided an information aggregation apparatus, configured in a requestor for information in an information aggregation system, the information aggregation apparatus including:

a generating unit configured to generate an aggregation request, the aggregation request including a source address, a destination address, a requested target device, requested information, and a requested aggregation action; wherein, the source address is an address of the requestor, and the destination address is an address of a receiver, there existing a security relationship between the requestor and the receiver;

an encrypting unit configured to encrypt the aggregation request according to the security relationship between the requestor and the receiver; and

a first processing unit configured to transmit the encrypted aggregation request to the receiver, and record the aggregation request in a request list.

According to a fourth aspect of the embodiments of this disclosure, there is provided an information aggregation apparatus, configured in a receiver receiving an aggregation request in an information aggregation system, the apparatus including:

a receiving unit configured to receive an aggregation request;

a decrypting unit configured to decrypt the aggregation request;

a first processing unit configured to, when the receiver is a target device of the aggregation request, prepare requested information, perform an aggregation action indicated by the aggregation request on the prepared information, and generate an aggregation reply, the aggregation reply including a source address, a destination address, a requested target device, and prepared requested information; wherein, the source address is an address of the receiver, the destination address is an address of a device transmitting the aggregation request, and the requested target device is the receiver;

an encrypting unit configured to encrypt the aggregation reply according to a security relationship between the receiver and the device transmitting the aggregation request; and

a second processing unit configured to transmit the encrypted aggregation reply to the device transmitting the aggregation request.

According to a fifth aspect of the embodiments of this disclosure, there is provided an information aggregation system, including a first device and a second device, the first device being configured to transmit an aggregation request and including the apparatus described in the third aspect, and the second device being configured to receive the aggregation request and including the apparatus described in the fourth aspect.

An advantage of the embodiments of this disclosure exists in that with the embodiments of this disclosure, information may be aggregated between mutually trusted devices in a secure manner. Hence, a device may aggregate information for an untrusted device without security concern.

With reference to the following description and drawings, the particular embodiments of this disclosure are disclosed in detail, and the principles of this disclosure and the manners of use are indicated. It should be understood that the scope of the embodiments of this disclosure is not limited thereto. The embodiments of this disclosure contain many alternations, modifications and equivalents within scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including/comprise/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the exemplary embodiments of this disclosure, and are used for setting forth the principles of this disclosure together with the description. It is clear and understood that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a network fault diagnosis system;

FIG. 2 is a schematic diagram of an information aggregation method of Embodiment 1;

FIG. 3 is a schematic diagram of a frame structure of an implementation of an aggregation request;

FIG. 4 is a schematic diagram of a frame structure of another implementation of an aggregation request;

FIG. 5 is a schematic diagram of an information aggregation method of Embodiment 2;

FIG. 6 is a schematic diagram of a frame structure of an implementation of an aggregation reply;

FIG. 7 is a schematic diagram of an information aggregation method of Embodiment 3;

FIG. 8 is a schematic diagram of an implementation of an aggregation request and an aggregation reply;

FIG. 9 is a schematic diagram of a frame structure of another implementation of an aggregation reply;

FIG. 10 is a schematic diagram of another implementation of an aggregation request and an aggregation reply;

FIG. 11 is a schematic diagram of an information aggregation apparatus of Embodiment 4;

FIG. 12 is a schematic diagram of an information aggregation apparatus of Embodiment 5;

FIG. 13 is a schematic diagram of a network device of Embodiment 6;

FIG. 14 is another schematic diagram of a network device of Embodiment 6;

FIG. 15 is a schematic diagram of a systematic structure of a network device of Embodiment 6; and

FIG. 16 is a schematic diagram of an information aggregation system of Embodiment 7.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within terms of the appended claims.

For the sake of convenience of description, an application scenario of the embodiments of this disclosure shall be described below with reference to an accompanying drawing. This scenario is illustrative only, and is not intended to limit the embodiments of this disclosure.

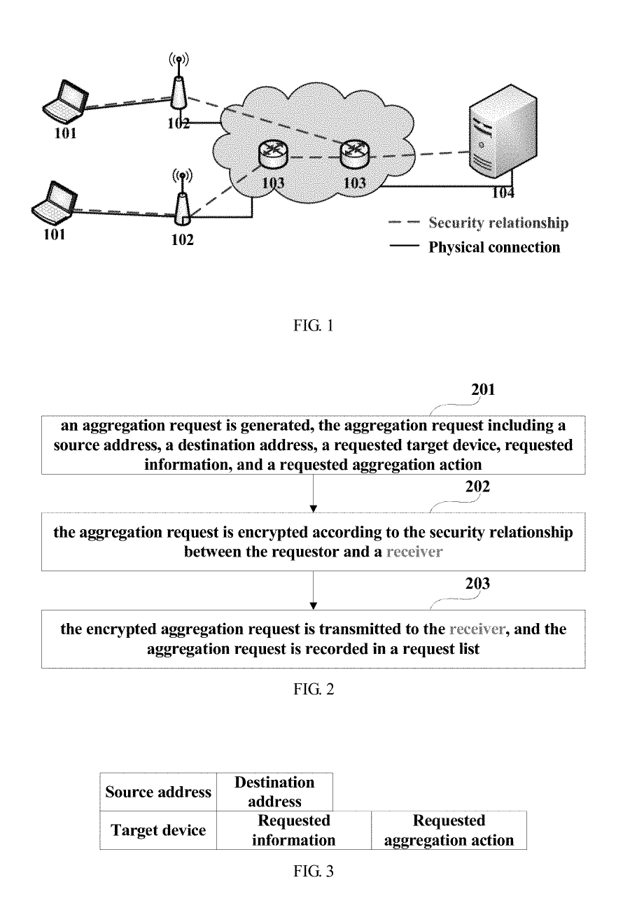

FIG. 1 is a schematic diagram of a security relationship in a network fault diagnosis system. As shown in FIG. 1, in the network fault diagnosis system 100, a terminal device 101, a network access device 102, an aggregation device 103 and a network fault diagnosis server 104 are included. In this embodiment, a security relationship may be established between any two devices, and two devices having a security relationship may be directly connected to each other via a communication medium, or may not be directly connected to each other. The security relationship may be established by using a network addressing manner based on a uniform resource locator (URL) between the devices that are not directly connected to each other, and information aggregation request and report may be performed therebetween.

The embodiments of this disclosure shall be described below with reference to the accompanying drawings.

### Embodiment 1

An embodiment of this disclosure provides an information aggregation method, applicable to a requestor for information (such as the server 104 shown in FIG. 1) in an information aggregation system (such as the network fault diagnosis system shown in FIG. 1). FIG. 2 is a schematic diagram of the method. Referring to FIG. 2, the method includes:

step 201: an aggregation request is generated, the aggregation request including a source address, a destination address, a requested target device, requested information, and a requested aggregation action;

step 202: the aggregation request is encrypted according to the security relationship between the requestor and a receiver; and

step 203: the encrypted aggregation request is transmitted to the receiver, and the aggregation request is recorded in a request list.

In this embodiment, the source address is an address of the requestor, i.e. an address of a device transmitting the aggregation request, such as an address of the above-described server 104; and the destination address is an address of the receiver, i.e. an address of a device receiving the aggregation request, such as an address of the aggregation device 103 shown in FIG. 1. In this embodiment, there exists a security relationship between the requestor and the receiver; the requested target device is an information source device, which is able to provide requested information in a measurement manner, etc., the requested information is information expected to be obtained by the requestor; and the requested aggregation action indicates aggregation actions needing to be performed on the requested information, such as tailoring, abstraction, isolation, and integration, etc. FIG. 3 is an example of a frame structure of the aggregation request.

In this embodiment, the requestor may encrypt the aggregation request according to the security relationship between it and the receiver. In this embodiment, a particular encryption manner is not limited; and furthermore, how to establish the security relationship shall be described later.

In this embodiment, a route between the requestor and the receiver used for transmitting the aggregation request may be established by using an existing method, which is not limited in this embodiment.

In this embodiment, effective aggregation requests are recorded in the request list. Table 1 is an example of the request list. As shown in Table 1, the request list contains records corresponding to transmitted aggregation requests, each record containing a source address, a destination address, a requested target device, requested information, and a requested aggregation action. Table 1 is only an example of the request list, and this embodiment is not limited thereto. Corresponding to contents contained in the aggregation requests, each record in the request list may further contain other information or omit some information.

TABLE 1

| | | | | Requested |
|---|---|---|---|---|
| Source | Destination | | Requested | aggregation |
| address | address | Target address | information | action |
| . . . | . . . | . . . | . . . | . . . |

Hence, when the requestor receives an aggregation reply, it may determine, according to whether the requested target device contained in the aggregation reply is located in the request list, whether to acquire information in the aggregation reply. For example, if the requested target device is located in the request list, it shows that the aggregation reply is directed to a local aggregation request, and the information in the aggregation reply may be acquired, which shall be particularly described in Embodiment 3.

In this embodiment, information needs to be aggregated between entrusted devices, and for any two devices in the information aggregation system, a security relationship may be established as demanded. In this embodiment, the requestor needs further to establish security relationships with other devices in the information aggregation system.

In this embodiment, establishment of a security relationship includes but not limited to the following actions:

1) association;

2) authentication; and

3) data encryption algorithm negotiation, and necessary key exchange.

As to the association, following actions need to be performed between two devices, but it is not limited thereto:

1) registering on each other for supporting information aggregation, such as registering on each other for supporting fault diagnostic information aggregation; and

2) indicating each other supported information aggregation actions, such as indicating each other supported fault diagnostic information aggregation actions.

The aggregation actions here include but not limited to: tailoring, abstraction, isolation, and integration. In this embodiment, the tailoring refers to performing reduction, and filtering, etc., on fault information, according to the indication of the aggregation request; the abstraction refers to analyzing information, and giving a conclusion, or an abstract, etc.; the isolation refers to re-organizing information for the purpose of security, so that an information receiver is unable to learn details of the information, such as a structure, etc.; for example, an isolation action must be performed between an information source and an information requestor in a case where there exists no security relationship between them; and the integration refers to integrating multiple types of information, or information coming from different information sources.

As to the authentication, it refers to verification of identity security performed by two devices, which may use an existing scheme. For example, an authentication method of a shared key provided in IEEE 802.11 is as follows:

1) both authentication parties obtain a preset shared key first in an off-line manner;

2) an authentication requestor transmits an authentication request message;

3) the other device receives the authentication request message, generates a string of bytes by using a wired equivalent privacy (WEP) algorithm and takes the string of bytes as an authentication challenge plaintext, and transmits the authentication challenge plaintext to the requestor;

4) the authentication requestor receives the authentication challenge plaintext, duplicates the authentication challenge plaintext and encrypts and encapsulates the authentication challenge plaintext by using the preset shared key based on the WEP algorithm, and feeds back the encapsulated message to the other device; and

5) the other device receives the encapsulated message, and if the encapsulated message is successfully decrypted by using the WEP algorithm and an integrity check value (ICV) is checked correct, compares the decrypted information with the above transmitted authentication challenge plaintext, if they are identical, transmits an authentication success message to the authentication requestor, and if they are different, transmits an authentication failure message to the authentication requestor.

Furthermore, an authentication method provided in the IEEE 802.1X standard may be used; however, this embodiment is not limited thereto.

In this embodiment, after success of the authentication, the two devices may perform negotiation on a subsequent aggregation information encryption method and exchange keys necessary for the encryption; wherein, an existing information encryption method capable of guaranteeing information integrity, effectiveness and security may likewise be adopted, which shall not be described herein any further.

In this embodiment, the security relationship is pre-established, and in a process of information aggregation, the above processing is performed directly according to the pre-established security relationship.

In an implementation of this embodiment, the number of the requested target device is one, and the aggregation request is a unicast aggregation request.

In this implementation, if the requestor and the target device have established a security relationship, the requestor may encrypt the aggregation request according to the security relationship, and transmit the aggregation request by taking an address of the target device as the destination address. Hence, information may be aggregated in a secure manner between entrusted devices.

In this implementation, if the requestor and the target device have not established a security relationship, the requestor may take an address of an intermediate device having security relationships with both the requestor and the target device as the destination address, encrypt the aggregation request according to the security relationship between the requestor and the intermediate device, and transmit the encrypted aggregation request to the intermediate device. Hence, a device may aggregate information for an untrusted device without security concern.

In another implementation of this embodiment, the number of the requested target device is multiple, and the aggregation request is a multicast aggregation request.

In this implementation, multiple devices may establish a security group, and a security relationship has been established between any two devices in the security group, a method for establishing the security relationship being as described above, and being not going to be described herein any further.

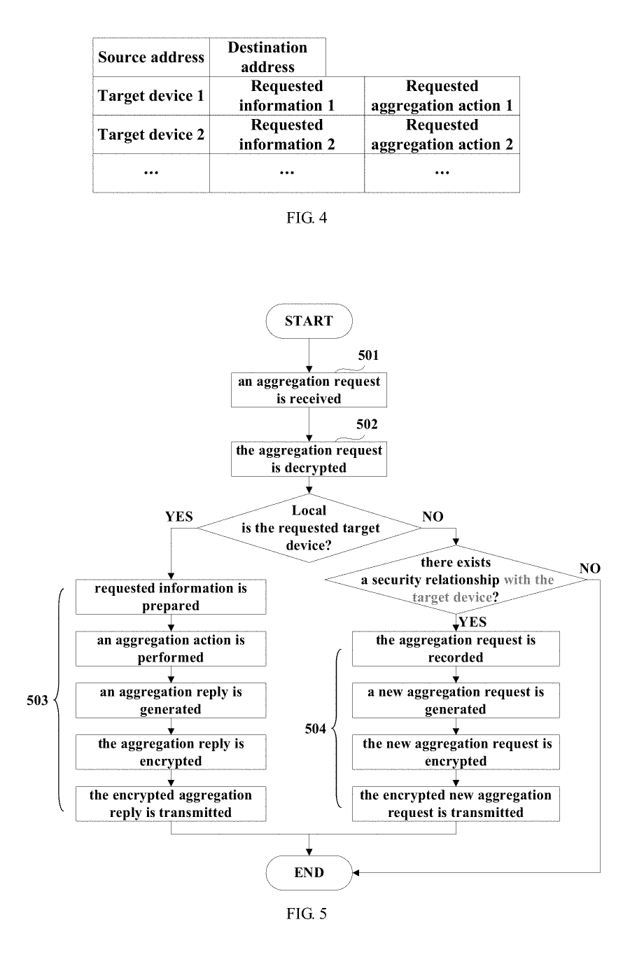

In this implementation, the number of the requested target device is multiple, and the multiple requested target devices and the receiver are in the same security group. In the aggregation request, in addition to the source address and the destination address, multiple requested target devices and requested information and requested aggregation actions to which each requested target device corresponds are further included. FIG. 4 is an example of a frame structure of the aggregation request.

In this implementation, the source address is the address of the requestor, and the destination address may be a unicast address or a multicast address. For the case of unicast address, the receiver to which the designation address corresponds is in the same security group as all target devices, and has established a security relationship with the requestor. And for the case of multicast address, the number of the receiver to which the designation address corresponds is multiple, the multiple receivers are in the same security group as the requestor, and each receiver is a target device or has established a security relationship(s) with one or more target devices.

In this implementation, the requestor may encrypt the aggregation request according to a security relationship(s) between it and one or more receivers in the aggregation request, transmit the encrypted aggregation request, and save the aggregation request in the request list.

With the method of this embodiment, information may be aggregated between mutually trusted devices in a secure manner, and a device may aggregate information for an untrusted device without security concern.

### Embodiment 2

An embodiment of this disclosure provides an information aggregation method, applicable to a device receiving an aggregation request, i.e. the receiver in the method of Embodiment 1, with contents identical to those in Embodiment 1 being not going to be described herein any further. FIG. 5 is a schematic diagram of the method. Referring to FIG. 5, the method includes:

step 501: an aggregation request is received;

step 502: the aggregation request is decrypted;

step 503: when the receiver is a target device requested by the aggregation request, requested information is prepared, an aggregation action indicated by the aggregation request is performed on the requested information, and an aggregation reply is generated; the aggregation reply is encrypted according to a security relationship between the receiver and the device transmitting the aggregation request, and the encrypted aggregation reply is transmitted to the device transmitting the aggregation request;

step 504: when the receiver is not the target device requested by the aggregation request and there exists a security relationship between the receiver and the target device requested by the aggregation request, the aggregation request is recorded in an aggregation list, a new aggregation request is generated, the new aggregation request is encrypted according to the security relationship between the receiver and the target device, and the encrypted new aggregation request is transmitted to the target device.

In an implementation, step 503 is optional, that is, a case where the receiver is not the target device requested by the aggregation request is only concerned in this implementation. In another implementation, step 504 is optional, that is, a case where the receiver is the target device requested by the aggregation request is only concerned in this implementation. Both steps 503 and 504 are shown in FIG. 5 for explanation of the embodiment of this disclosure, and are not intended to limit the embodiment of this disclosure.

In an implementation of this embodiment, the number of the requested target device is only one, and the aggregation request is a unicast aggregation request. In this implementation, a device receives a aggregation request (step 501), the destination address in the aggregation request is an address of the device, and if the received aggregation request can be successfully decrypted (step 502), it shows that the local device is the destination device of the aggregation request, and subsequent processing may be performed; otherwise, it shows that the local device is not the destination device of the aggregation request, and the aggregation request may be discarded.

In this implementation, whether the local device is the target device requested by the aggregation request may be determined by decrypting the received aggregation request. For example, if the requested target device in the aggregation request is the local device, it shows that the local device is the target device requested by the aggregation request.

In an implementation, the local device is the target device requested by the aggregation request, the receiver may prepare the information requested by the aggregation request in step 503. Here, the requested information may be the above-described fault diagnosis information, which may be extracted by measurement or from locally-stored information. Then, the aggregation action, such as tailoring, abstraction, or integration, etc., requested by the aggregation request, is performed on the requested information, so as to generate an aggregation reply.

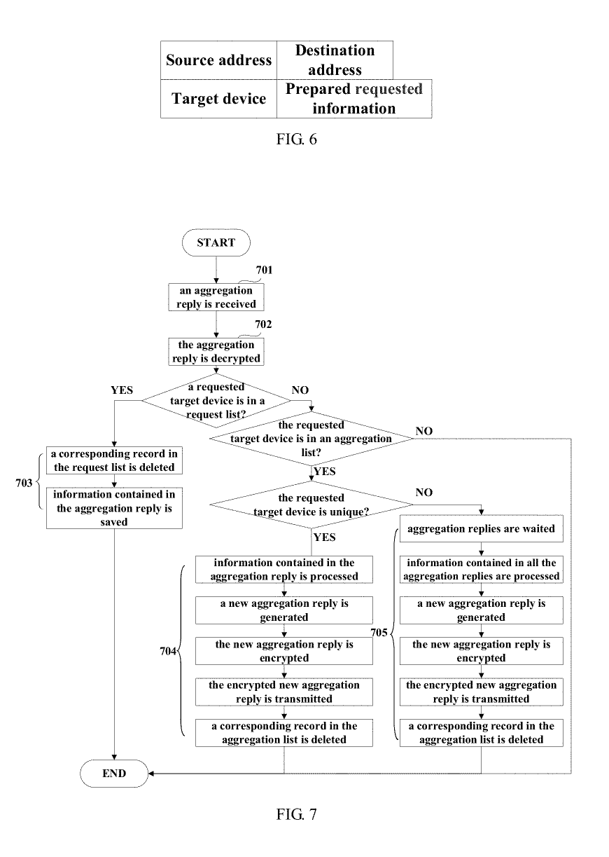

In this implementation, the aggregation reply includes: a source address, a destination address, a target device, and prepared information. FIG. 6 is a schematic diagram of a frame structure of the aggregation reply. As shown in FIG. 6, still taking what described above as an example, in the aggregation reply, the source address is an address of the receiver, the target device is the receiver, the destination address is an address of a device transmitting the aggregation request, and the prepared information is the fault diagnosis information after the aggregation action is performed.

In another implementation, the local device is not the target device requested by the aggregation request and the local device has established a security relationship with the target device, in step 504, the receiver may record the aggregation request in the aggregation list, and generate a new aggregation request; then encrypt the new aggregation request according to the security relationship between it and the target device, and transmit the encrypted new aggregation request to the target device.

In this implementation, the aggregation list records effective aggregation requests. Table 2 is an example of the aggregation list. As shown in Table 2, the aggregation list contains records corresponding to transmitted aggregation requests, each record containing a source address, a destination address, a requested target device, requested information, and a requested aggregation action. Table 2 is only an example of the aggregation list, and this embodiment is not limited thereto. Corresponding to contents contained in the aggregation requests, each record in the aggregation list may further contain other information or omit some information.

TABLE 2

| | | | | Requested |
|---|---|---|---|---|
| Source | Destination | | Requested | aggregation |
| address | address | Target address | information | action |
| . . . | . . . | . . . | . . . | . . . |

Hence, when the receiver receives the aggregation reply, it may determine, according to whether the target device contained in the aggregation reply is located in the aggregation list, whether to forward the aggregation reply. For example, if the target device is located in the aggregation list, and the target device indicated by a corresponding record in the aggregation list is the requested target device contained in the aggregation reply or contains the requested target device contained in the aggregation reply, the aggregation reply will be forwarded, which shall be particularly described in Embodiment 3.

In this implementation, in the new aggregation request, a new source address is an address of the receiver, a new destination address is an address of the requested target device contained in the aggregation request, a new target device is the requested target device contained in the aggregation request, new requested information and a new requested aggregation action are the requested information and the requested aggregation action contained in the aggregation request.

In another implementation of this embodiment, the number of the requested target device is multiple, and the aggregation request is a multicast aggregation request. In this implementation, a device receives a aggregation request (step 501), and if an address of the device is the destination address in the aggregation request or is contained in a multicast designation address in the aggregation request and the device is able to successfully decrypt the aggregation request (step 502), it shows that the local device is the destination device of the aggregation request, and subsequent processing may be performed; otherwise, it shows that the local device is not the destination device of the aggregation request, and the aggregation request may be discarded.

In this implementation, whether the local device is one of the target devices requested by the aggregation request may be determined by decrypting the received aggregation request. For example, if the requested target devices in the aggregation request contain the local device, it shows that the local device is one of the target devices requested by the aggregation request.

In an implementation, the local device is one of the target devices requested by the aggregation request, and the receiver may prepare the information requested by the aggregation request in step 503. Then, the aggregation action requested by the aggregation request is performed on the requested information, so as to generate the aggregation reply.

In this implementation, as shown in FIG. 6, in the aggregation reply, the source address is an address of the receiver, the target device is the receiver, the destination address is an address of a device transmitting the aggregation request, and the prepared information is the requested information after the aggregation action is performed, such as fault diagnosis information.

In another implementation, the local device is not one of the target devices requested by the aggregation request, but the local device has established a security relationship(s) with one or more of the target devices and the target devices have not established a security relationship with the device transmitting the aggregation request (a source device of the aggregation request, i.e. the above-described requestor), in step 504, the receiver may record the aggregation request in the aggregation list, and generate the new aggregation request.

In this implementation, if the receiver has established a security relationship with only one of the target devices, the receiver may generate the new aggregation request in the manner of generating the unicast aggregation request in Embodiment 1, encrypt the new aggregation request according to the security relationship between it and the target device, and transmit the encrypted new aggregation request to the target device. In the new aggregation request, the source address is an address of the receiver, the destination address is an address of the target device, the requested target device is the target device, the requested information is requested information to which the target device corresponds, and the requested aggregation action is requested aggregation action to which the target device corresponds.

In this implementation, if the receiver has established security relationships with multiple target devices, for the target devices in the same security group as the receiver, the receiver may generate the new aggregation request in the manner of generating the multicast aggregation request in Embodiment 1, encrypt the new aggregation request and transmit the encrypted new aggregation request. In the new aggregation request, the source address is an address of the receiver, the destination address is a multicast address of the security group, the requested target device is a target device in the same security group as the receiver, the requested information is requested information to which the target devices in the same security group as the receiver correspond, and the requested aggregation action is requested aggregation actions to which the target devices in the same security group as the receiver correspond. Furthermore, for a target device having established a security relationship with the receiver but having not established a security relationship with other target devices, the receiver may generate the new aggregation request in the manner of generating the unicast aggregation request in Embodiment 1, encrypt the new aggregation request and transmit the encrypted new aggregation request. In the new aggregation request, the source address is an address of the receiver, the destination address is an address of the target device, the requested target device is the target device, the requested information is requested information to which the target device corresponds, and the requested aggregation action is requested aggregation action to which the target device corresponds.

In this embodiment, a method for establishing the security relationship is identical to that in Embodiment 1, which shall not be described herein any further.

With the method of this embodiment, information may be aggregated between mutually trusted devices in a secure manner, and a device may aggregate information for an untrusted device without security concern.

### Embodiment 3

An embodiment of this disclosure provides an information aggregation method, applicable to a device receiving an aggregation reply. Corresponding to the methods in embodiments 1 and 2, the device receiving an aggregation reply may possibly be the requestor in Embodiment 1, or may be the receiver in Embodiment 2, with contents identical to those in embodiments 1 and 2 being not going to be described herein any further. FIG. 7 is a schematic diagram of the method. Referring to FIG. 7, the method includes:

step 701: an aggregation reply is received;

step 702: the aggregation reply is decrypted;

step 703: when a requested target device contained in the aggregation reply is in a request list, a corresponding record in the request list is deleted, and information contained in the aggregation reply is saved;

step 704: when the requested target device contained in the aggregation reply is in an aggregation list and a target device indicated by a corresponding record in the aggregation list is the requested target device (the requested target device is unique), information contained in the aggregation reply is processed, a new aggregation reply is generated, the new aggregation reply is encrypted, the encrypted new aggregation reply is transmitted, and a corresponding record in the aggregation list is deleted; and

step 705: when the requested target device contained in the aggregation reply is in the aggregation list and target devices indicated by a corresponding record in the aggregation list are multiple target devices containing the requested target device (the requested target device is not unique), aggregation replies feedback by other requested target devices are waited, information contained in all the aggregation replies are processed, a new aggregation reply is generated, the new aggregation reply is encrypted, the encrypted new aggregation reply is transmitted, and a corresponding record in the aggregation list is deleted.

In this embodiment, the processing in steps 704 and 705 are isolation actions, and alternatively, the processing may further include other aggregation actions indicated by corresponding records in the aggregation list, such as tailoring, abstraction, and integration, etc.

In this embodiment, similar to Embodiment 2, steps 703, 704 and 705 are all shown in FIG. 7 for integrally describing the embodiment of this disclosure, which does not mean that the three steps are indispensable in particular implementation. For example, according to different concerns, any one or two of steps 703-705 in the method of this embodiment may be omitted.

In an implementation of this embodiment, the number of the requested target device is one, and the aggregation request is a unicast aggregation request. In this implementation, a device receives a aggregation reply (step 701), and if the destination address is an address of the device and the device is able to successfully decrypt the aggregation request (step 702), it shows that the local device is the destination device of the aggregation reply, and subsequent processing may be performed; otherwise, it shows that the local device is not the destination device of the aggregation reply, and the aggregation reply may be discarded.

In this implementation, whether the target device contained in the aggregation reply is in the request list or in the aggregation list may be determined by decrypting the received aggregation reply. If it is in the request list, it shows that the aggregation reply is directed to an aggregation request of the local device, and information therein may be acquired; and if it is in the aggregation list, it shows that the aggregation reply is not directed to an aggregation request of the local device, and it further needs to be forwarded.

In an implementation, the target device contained in the aggregation reply is in the request list, in step 703, the device deletes a corresponding record in the request list, i.e. a record to which the requested target device corresponds, and saves information in the aggregation reply.

In another implementation, the target device contained in the aggregation reply is in the aggregation list, in step 704, the device may process the information in the aggregation reply, such as isolation, and alternatively, perform other processing according to aggregation actions indicated by the record in the aggregation list. Thereafter, the device may generate a new aggregation reply, encrypt the new aggregation reply according to a security relationship between the device and a destination device in the new aggregation reply (a source indicated by the record in the aggregation list), and transmit the encrypted new aggregation reply; and furthermore, the device may delete the corresponding record in the aggregation list.

In this implementation, in the new aggregation reply, a source address is an address of the device, a destination address is an address of the source indicated by the corresponding record in the aggregation list, a target device is the target device receiving the above aggregation reply, and requested information is information after the information in the above aggregation reply is processed.

FIG. 8 is a schematic diagram of the aggregation request and the aggregation reply of this implementation. As shown in FIG. 8, the dotted line denotes a security relationship, and the solid line denotes physical connection. A server is a requestor for information, terminal equipment 1 (TE1) is an information source device, i.e. a target device, an access point 1 (AP1) may be an information source device, and may also be an intermediate device, which has security relationships with both TE1 and the server, but there exists no security relationship between TE1 and the server, and an aggregator 1 and an aggregator 2 are connection devices in the network.

As shown in FIG. 8, when the server is a requestor and AP1 is a target device, the process includes:

step 801: server transmits an aggregation request to AP1;

step 802: AP1 performs aggregation processing according to the aggregation request; and

step 803: AP1 feeds back an aggregation reply to the server.

In this process, the server may perform the processing in step 801 by using the method shown in FIG. 2, and AP1 may perform the processing in steps 802-803 by using steps 501-503 shown in FIG. 5, hence, the server may perform subsequent processing by using steps 701-703 shown in FIG. 7.

As shown in FIG. 8, when the server is a requestor and TE1 is a target device, AP1 functions as an intermediate device, and the process includes:

step 801′: server transmits an aggregation request to AP1;

step 802′: AP1 performs aggregation processing according to the aggregation request, generates a new aggregation request, and transmits the new aggregation request to TE1;

step 803′: TE1 performs aggregation processing according to the new aggregation request, and feeds back an aggregation reply to AP1; and

step 804′: AP1 performs aggregation processing according to the aggregation reply, generates a new aggregation reply, and feeds back the new aggregation reply to the server.

In this process, the server may perform the processing in step 801′ by using the method shown in FIG. 2, AP1 may perform the processing in step 802′ by using steps 501-502 and 504 shown in FIG. 5, TE1 may perform the processing in step 803′ by using steps 501-503 shown in FIG. 5, and AP1 may perform the processing in step 804′ by using steps 701-702 and 704 shown in FIG. 7, hence, the server may perform subsequent processing by using steps 701-703 shown in FIG. 7.

In another implementation of this embodiment, the number of the requested target device is multiple, and the aggregation request is a multicast aggregation request. In this implementation, a device receives a aggregation reply (step 701), and if a destination address is the address of the device and the device is able to successfully decrypt the aggregation reply (step 702), it shows that the local device is the destination device of the aggregation reply, and subsequent processing may be performed; otherwise, it shows that the local device is not the destination device of the aggregation reply, and the aggregation reply may be discarded.

In this implementation, similar to the previous implementation, whether the target device contained in the aggregation reply is in the request list or in the aggregation list may be determined by decrypting the aggregation reply. If it is in the request list, it shows that the aggregation reply is directed to an aggregation request of the local device, and information therein may be acquired; and if it is in the aggregation list, it shows that the aggregation reply is not directed to an aggregation request of the local device, and it further needs to be forwarded.

In an implementation, the target device contained in the aggregation reply is in the request list, in step 703, the device deletes a corresponding record in the request list, i.e. a record to which the requested target device corresponds, and saves information in the aggregation reply.

In another implementation, the target device contained in the aggregation reply is in the aggregation list and target devices indicated by corresponding records in the aggregation list are multiple, in which the target device contained in the aggregation reply is contained, in step 704, the device may save the aggregation reply, and after waiting for aggregation replies from all other target devices or waiting for a specific period of time, process the information in the all received aggregation replies to which corresponding record corresponds, such as isolation processing, or perform integration or other aggregation actions on information in these aggregation replies, generate a new aggregation reply, encrypt the new aggregation reply according to a security relationship between the device and a destination device in the new aggregation reply (a source indicated by the record in the aggregation list), and transmit the encrypted new aggregation reply; and furthermore, the device may delete the corresponding record in the aggregation list.

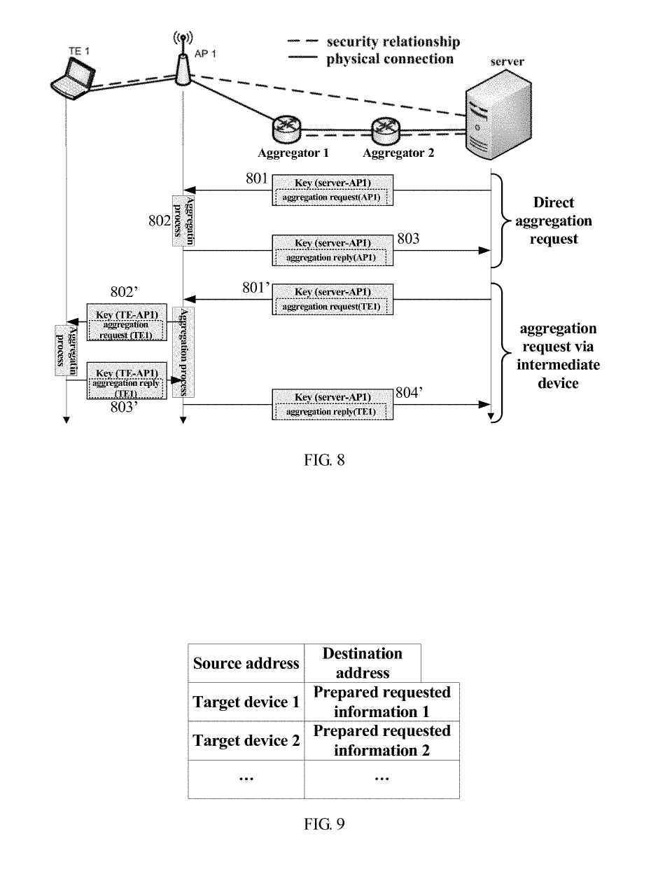

In this implementation, in the new aggregation reply, a source address is an address of the device, a destination address is an address of the source indicated by the corresponding record in the aggregation list, target devices are all the above-described target devices, and requested information is information after the information in all the above aggregation replies is processed. FIG. 9 is a schematic diagram of a frame structure of the new aggregation reply.

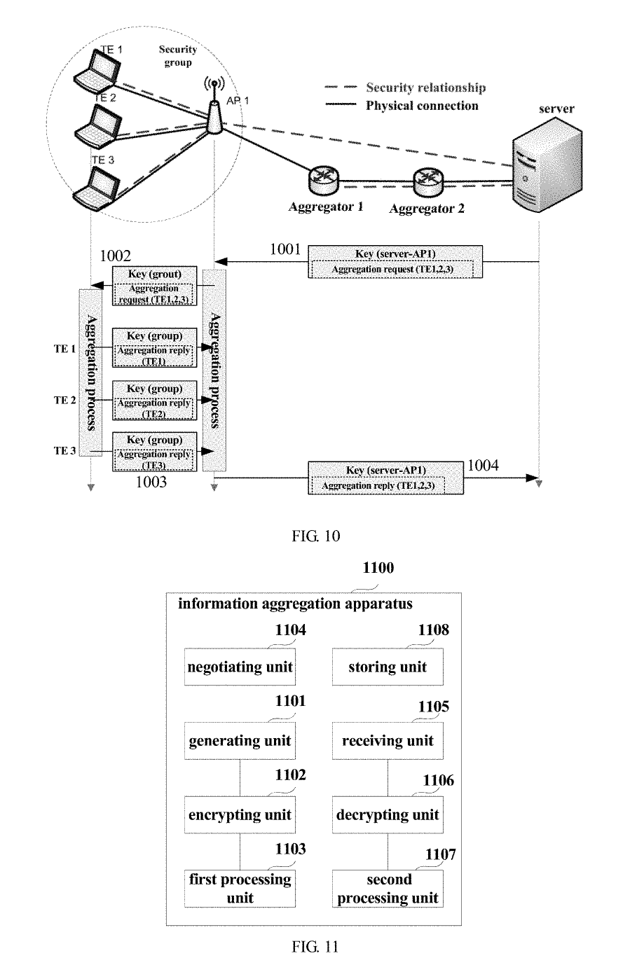

FIG. 10 is a schematic diagram of the aggregation request and the aggregation reply of this implementation. As shown in FIG. 10, the dotted line denotes a security relationship, and the solid line denotes physical connection. A server is a requestor for information, terminal equipment 1 (TE1), terminal equipment 2 (TE2) and terminal equipment 3 (TE3) are information source devices, i.e. target devices, an access point 1 (AP1) may be an information source device, and may also be an intermediate device, which has security relationships with TE1, TE2, TE3 and the server, but there exists no security relationship between TE1, TE2, TE3 and the server, and an aggregator 1 and an aggregator 2 are connection devices in the network, respectively.

As shown in FIG. 10, when the server is a requestor and TE1, TE2, TE3 are target devices, AP1 functions as an intermediate device, and the process includes:

step 1001: the server transmits an aggregation request to AP1;

step 1002: AP1 performs aggregation processing according to the aggregation request, generates a new aggregation request, and transmits the new aggregation request to TE1, TE2, TE3;

step 1003: TE1, TE2, TE3 perform aggregation processing according to the new aggregation request, and feeds back an aggregation reply to AP1; and

step 1004: AP1 performs aggregation processing according to the aggregation reply, generates a new aggregation reply, and feeds back the new aggregation reply to the server.

In this process, the server may perform the processing in step 1001 by using the method shown in FIG. 2, AP1 may perform the processing in step 1002 by using steps 501-502 and 504 shown in FIG. 5, TE1, TE2, TE3 may perform the processing in step 1003 by using steps 501-503 shown in FIG. 5, and AP1 may perform the processing in step 1004 by using steps 701-702 and 705 shown in FIG. 7, hence, the server may perform subsequent processing by using steps 701-703 shown in FIG. 7.

In this embodiment, a method for establishing the security relationship is identical to that in Embodiment 1, and shall not be described herein any further.

With the method of this embodiment, information may be aggregated between mutually trusted devices in a secure manner, and a device may aggregate information for an untrusted device without security concern.

The information aggregation method of the embodiment is described above with reference to three embodiments from points of angle of transmitting an aggregation request, receiving an aggregation request and receiving an aggregation reply. And it is understood by those skilled in the art that the above three embodiments are not independent of each other, and may be used in a combined manner in particular implementation.

### Embodiment 4

An embodiment of this disclosure provides an information aggregation apparatus, configured in a requestor for information in an information aggregation system. This apparatus corresponds to the methods of embodiments 1 and 3, with contents identical to those in embodiments 1 and 3 being not going to be described herein any further.

FIG. 11 is a schematic diagram of the apparatus. As shown in FIG. 11, the information aggregation apparatus 1100 includes: a generating unit 1101, an encrypting unit 1102 and a first processing unit 1103.

In this embodiment, the generating unit 1101 is configured to generate an aggregation request, the aggregation request including a source address, a destination address, a requested target device, requested information, and a requested aggregation action; wherein, the source address is an address of the requestor, and the destination address is an address of a receiver, there existing a security relationship between the requestor and the receiver. The encrypting unit 1102 is configured to encrypt the aggregation request according to the security relationship between the requestor and the receiver. And the first processing unit 1103 is configured to transmit the encrypted aggregation request to the receiver, and record the aggregation request in a request list.

In this embodiment, as shown in FIG. 11, the apparatus 1100 may further include: a negotiating unit 1104 configured to establish a security relationship with other devices in the information aggregation system, including registering on each other for supporting information aggregation, indicating each other supported information aggregation actions, authenticating, negotiating encryption algorithm, and exchanging keys necessary for the encryption. The method for establishing the security relationship has been described in Embodiment 1, the contents of which being incorporated herein, and being not going to be described herein any further.

In an implementation of this embodiment, the number of the requested target device is one, and the aggregation request is a unicast aggregation request, a frame structure of which being as shown in FIG. 3.

In this implementation, the receiver may possibly be a target device, and may also be an intermediate device having established a security relationship with a target device.

In another implementation of this embodiment, the number of the requested target device is multiple, and the aggregation request is a multicast aggregation request, a frame structure of which being as shown in FIG. 4.

In this implementation, the destination address in the aggregation request may be a unicast address, and may also be a multicast address. If it is a unicast address, the receive device is an intermediate device in the same security group as the multiple target devices, and has established a security relationship with the requestor. If it is a multicast address, the receiver is multiple. In an implementation, the multiple receivers are the multiple target devices. And in another implementation, the multiple receivers have established security relationships with the multiple target devices.

In this embodiment, as shown in FIG. 11, the apparatus 1100 may further include a receiving unit 1105, a decrypting unit 1106 and a second processing unit 1107. The receiving unit 1105 is configured to receive an aggregation reply, the decrypting unit 1106 is configured to decrypt the aggregation reply, and the second processing unit 1107 is configured to, after the decrypting unit 1106 decrypts successfully, perform corresponding processing on the aggregation reply according to the request list and the aggregation list.

In an implementation, the target device in the aggregation reply is in the request list, the second processing unit 1107 determines that the aggregation reply is directed to an aggregation request transmitted by the local device, deletes a corresponding record in the request list, and saves prepared information in the aggregation reply.

In an implementation, the target device in the aggregation reply is in the aggregation list, the second processing unit 1107 determines that the aggregation reply is not directed to an aggregation request transmitted by the local device, and needs to forward the aggregation reply.

In a case, the target device indicated by the corresponding record in the aggregation list is the target device in the aggregation reply. For example, in a case of one target device, the second processing unit 1107 processes the prepared information in the aggregation reply (such as isolation, and alternatively, other aggregation actions may further be performed, as described above), and generates a new aggregation reply, the new aggregation reply including: a source address, a destination address, a target device, and processed prepared information. In this case, the source address is an address of the requestor, the destination address is an address of the source indicated by the corresponding record in the aggregation list, and the target device is the target device in the aggregation reply. In this implementation, the encrypting unit 1102 encrypts the new aggregation reply according to the security relationship between the requestor and the source indicated by the corresponding record in the aggregation list, and the first processing unit 1103 transmits the encrypted new aggregation reply to the source, and deletes the corresponding record in the aggregation list.

In another case, the target device indicated by the corresponding record in the aggregation list is multiple target devices containing the target device in the aggregation reply. For example, in a case of multiple target devices, the second processing unit 1107 saves the prepared information in the aggregation reply, waits for aggregation replies fed back by other target devices, processes prepared information in all the aggregation replies, and generates a new aggregation reply. In this case, the new aggregation reply includes a source address, a destination address, a target device, and processed prepared information. In this case, the source address is an address of the requestor, the destination address is an address of the source indicated by the corresponding record in the aggregation list, and the target device is the above multiple target devices. In this implementation, the encrypting unit 1102 encrypts the new aggregation reply according to the security relationship between the requestor and the source indicated by the corresponding record in the aggregation list, and the first processing unit 1103 transmits the encrypted new aggregation reply to the source, and deletes the corresponding record in the aggregation list.

In this embodiment, as shown in FIG. 11, the apparatus 1100 may further include a storing unit 1108 configured to store the above request list and aggregation list. The request list and aggregation list have been described in Embodiment 1, the contents of which being incorporated herein, and being not going to be described herein any further.

With the apparatus of this embodiment, information may be aggregated between mutually trusted devices in a secure manner, and a device may aggregate information for an untrusted device without security concern.

### Embodiment 5

An embodiment of this disclosure provides an information aggregation apparatus, configured in a receiver receiving an aggregation request in an information aggregation system. This apparatus corresponds to the methods of embodiments 2 and 3, with contents identical to those in embodiments 2 and 3 being not going to be described herein any further.

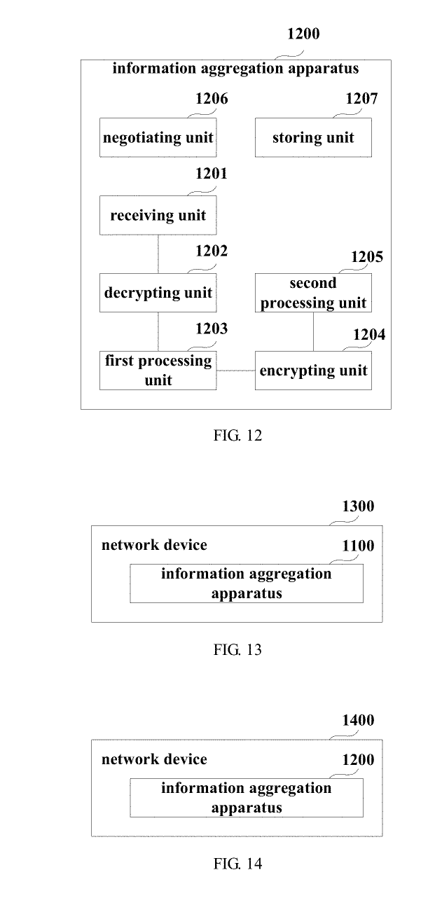

FIG. 12 is a schematic diagram of the apparatus. As shown in FIG. 12, the information aggregation apparatus 1200 includes: a receiving unit 1201, a decrypting unit 1202, a first processing unit 1203, an encrypting unit 1204 and a second processing unit 1205.

In this embodiment, the receiving unit 1201 is configured to receive an aggregation request. Contents of the aggregation request have been described in Embodiment 1, which are incorporated herein, and shall not be described herein any further. And the decrypting unit 1202 is configured to decrypt the aggregation request.

In an implementation, the receiver is a target device of the above aggregation request, and the first processing unit 1203 prepares requested information, performs an aggregation action indicated by the aggregation request on the prepared information, and generates an aggregation reply, the aggregation reply including a source address, a destination address, a target device, and prepared information; wherein, the source address is an address of the receiver, the destination address is an address of a device transmitting the aggregation request, and the target device is the receiver. In this implementation, the encrypting unit 1204 is configured to encrypt the aggregation reply according to a security relationship between the receiver and the device transmitting the aggregation request, and the second processing unit 1205 is configured to transmit the encrypted aggregation reply to the device transmitting the aggregation request.

In another implementation, the receiver is not the target device of the above aggregation request and the receiver has established a security relationship with the target device of the above aggregation request, and the first processing unit 1203 records the aggregation request in the aggregation list, and generates a new aggregation request, the new aggregation request including: a source address, a destination address, a requested target device, requested information, and a requested aggregation action; wherein, the source address is an address of the receiver, the destination address is an address of the target device or a multicast address containing at least one target device in the same security group as the receiver. In this implementation, the encrypting unit 1204 encrypts the new aggregation request according to a security relationship between the receiver and the above target device, and the second processing unit 1205 transmits the encrypted new aggregation request to the target device.

In this embodiment, as shown in FIG. 12, the apparatus 1200 may further include:

a negotiating unit 1206 configured to establish a security relationship with other devices in the information aggregation system, including registering on each other for supporting information aggregation, indicating each other supported information aggregation actions, authenticating, negotiating encryption algorithm, and exchanging keys necessary for the encryption. The method for establishing the security relationship has been described in Embodiment 1, the contents of which being incorporated herein, and being not going to be described herein any further.

In this embodiment, the receiving unit 1201 may further receive an aggregation reply, the decrypting unit 1202 may further decrypt the aggregation reply, and after successful decryption by the decrypting unit 1202, the first processing unit 1203 performs corresponding processing on the aggregation reply according to the request list and the aggregation list.

In an implementation, the target device in the aggregation reply is in the request list, and the first processing unit 1203 determines that the aggregation reply is directed to an aggregation request transmitted by the local device, deletes the corresponding record in the request list, and saves the prepared information in the aggregation reply.

In an implementation, the target device in the aggregation reply is in the aggregation list, and the first processing unit 1203 determines that the aggregation reply is not directed to an aggregation request transmitted by the local device, and needs to forward the aggregation reply.

In a case, the target device indicated by the corresponding record in the aggregation list is the target device in the aggregation reply. For example, in a case of one target device, the first processing unit 1203 processes the prepared information in the aggregation reply (such as isolation, and alternatively, other aggregation actions may further be performed, as described above), and generates a new aggregation reply, the new aggregation reply including a source address, a destination address, a target device, and processed prepared information; wherein, the source address is an address of the receiver, the destination address is an address of a source indicated by the corresponding record in the aggregation list, and the target device is the target device in the aggregation reply. In this implementation, the encrypting unit 1202 encrypts the new aggregation reply according to a security relationship between the receiver and the source indicated by the corresponding record in the aggregation list, and the second processing unit 1203 transmits the encrypted new aggregation reply to the source, and deletes the corresponding record in the aggregation list.

In another case, the target device indicated by the corresponding record in the aggregation list is multiple target devices containing the target device in the aggregation reply. For example, in a case of multiple target devices, the first processing unit 1203 saves the prepared information in the aggregation reply, waits for aggregation replies fed back by other target devices, processes prepared information in all aggregation replies, and generates a new aggregation reply, the new aggregation reply including a source address, a destination address, a target device, and processed prepared information; wherein, the source address is an address of the receiver, the destination address is an address of a source indicated by the corresponding record in the aggregation list, and the target device is the above multiple target devices. In this implementation, the encrypting unit 1202 encrypts the new aggregation reply according to a security relationship between the receiver and the source indicated by the corresponding record in the aggregation list, and the second processing unit 1203 transmits the encrypted new aggregation reply to the source, and deletes the corresponding record in the aggregation list.

In this embodiment, as shown in FIG. 12, the apparatus 1200 may further include a storing unit 1207 configured to store the above request list and aggregation list. The request list and aggregation list have been described in Embodiment 1, the contents of which being incorporated herein, and being not going to be described herein any further.

With the apparatus of this embodiment, information may be aggregated between mutually trusted devices in a secure manner, and a device may aggregate information for an untrusted device without security concern.

### Embodiment 6

An embodiment of this disclosure provides a network device.

In an implementation, the network device is a requestor for information in an information aggregation system. In this implementation, the network device is configured with the information aggregation apparatus 1100 described in Embodiment 4.

FIG. 13 is a schematic diagram of the network device. As shown in FIG. 13, the network device 1300 includes an information aggregation apparatus 1100, the apparatus 1100 being configured to: generate an aggregation request, the aggregation request including a source address, a destination address, a requested target device, requested information, and a requested aggregation action; wherein, the source address is an address of the requestor, and the destination address is an address of a receiver, there existing a security relationship between the requestor and the receiver; encrypt the aggregation request according to the security relationship between the requestor and the receiver; and transmit the encrypted aggregation request to the receiver, and record the aggregation request in a request list.

As the information aggregation apparatus 1100 has been described in embodiments 1, 3 and 4 in detail, the contents of which are incorporated herein, and shall not be described herein any further.

In another implementation, the network device is a device receiving an aggregation request in an information aggregation system. In this implementation, the network device is configured with the information aggregation apparatus 1200 described in Embodiment 5.

FIG. 14 is a schematic diagram of the network device. As shown in FIG. 14, the network device 1400 includes an information aggregation apparatus 1200, the apparatus 1200 being configured to: receive an aggregation request; decrypt the aggregation request; when the receiver is a target device of the aggregation request, prepare requested information, perform an aggregation action indicated by the aggregation request on the prepared information, and generate an aggregation reply, the aggregation reply including a source address, a destination address, a requested target device, and prepared requested information; wherein, the source address is an address of the receiver, the destination address is an address of a device transmitting the aggregation request, and the requested target device is the receiver; encrypt the aggregation reply according to a security relationship between the receiver and the device transmitting the aggregation request; and transmit the encrypted aggregation reply to the device transmitting the aggregation request.

As the information aggregation apparatus 1200 has been described in embodiments 2, 3 and 5 in detail, the contents of which are incorporated herein, and shall not be described herein any further.

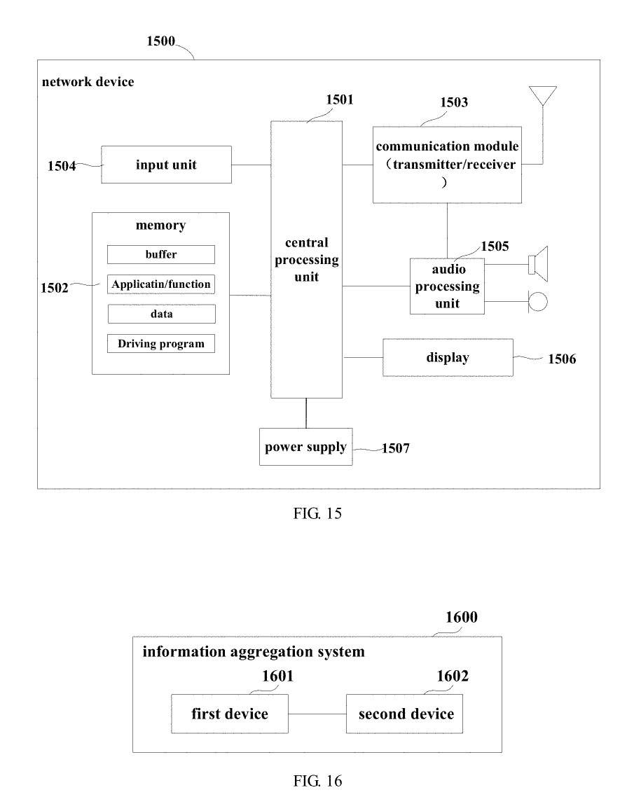

FIG. 15 is a schematic diagram of a systematic structure of the network device. As shown in FIG. 15, the network device 1500 may include a central processing unit 1501 and a memory 1502, the memory 1502 being coupled to the central processing unit 1501. It should be noted that this figure is illustrative only, and other types of structures may also be used, so as to supplement or replace this structure and achieve a telecommunications function or other functions.

In an implementation, the functions of the information aggregation apparatus described in Embodiment 4 may be integrated into the central processing unit 1501. In this implementation, the central processing unit 1501 may be configured to: generate an aggregation request, the aggregation request including a source address, a destination address, a requested target device, requested information, and a requested aggregation action; wherein, the source address is an address of the requestor, and the destination address is an address of a receiver, there existing a security relationship between the requestor and the receiver; encrypt the aggregation request according to the security relationship between the requestor and the receiver; and transmit the encrypted aggregation request to the receiver, and record the aggregation request in a request list.

In another implementation, the functions of the information aggregation apparatus described in Embodiment 5 may be integrated into the central processing unit 1501. In this implementation, the central processing unit 1501 may be configured to: receive an aggregation request; decrypt the aggregation request; when the receiver is a target device of the aggregation request, prepare requested information, perform an aggregation action indicated by the aggregation request on the prepared information, and generate an aggregation reply, the aggregation reply including a source address, a destination address, a requested target device, and prepared requested information; wherein, the source address is an address of the receiver, the destination address is an address of a device transmitting the aggregation request, and the target device is the receiver; encrypt the aggregation reply according to a security relationship between the receiver and the device transmitting the aggregation request; and transmit the encrypted aggregation reply to the device transmitting the aggregation request.

In another implementation, the information aggregation apparatuses described in embodiments 4 and 5 and the central processing unit 1501 may be configured separately. For example, the information aggregation apparatuses may be configured as chips connected to the central processing unit 1501, with their functions being realized under control of the central processing unit 1501.

As shown in FIG. 15, the network device 1500 may further include a communication module 1503, an input unit 1504, an audio processing unit 1505, a display 1506 and a power supply 1507. It should be noted that the network device 1500 does not necessarily include all the parts shown in FIG. 15, and furthermore, the network device 1500 may include parts not shown in FIG. 15, and the prior art may be referred to.

As shown in FIG. 15, the central processing unit 1501 is sometimes referred to as a controller or control, and may include a microprocessor or other processor devices and/or logic devices. The central processing unit 1501 receives input and controls operations of every component of the network device 1500.

In this embodiment, the memory 1502 may be, for example, one or more of a buffer memory, a flash memory, a hard drive, a mobile medium, a volatile memory, a nonvolatile memory, or other suitable devices, which may store the above request list and aggregation list, and may further store a program executing related information. And the central processing unit 1501 may execute the program stored in the memory 1502, so as to realize information storage or processing, etc. Functions of other parts are similar to those of the prior art, which shall not be described herein any further. The parts of the network device 1500 may be realized by specific hardware, firmware, software, or any combination thereof, without departing from the scope of the present disclosure.

With the network device of this embodiment, information may be aggregated between mutually trusted devices in a secure manner, and a device may aggregate information for an untrusted device without security concern.

### Embodiment 7

An embodiment of this disclosure provides an information aggregation system. FIG. 16 is a schematic diagram of the system. As shown in FIG. 16, the system 1600 includes a first device 1601 and a second device 1602.

In this embodiment, the first device 1601 is configured to transmit an aggregation request and configured with the information aggregation apparatus described in Embodiment 4, and the second device 1602 is configured to receive the aggregation request and configured with the information aggregation apparatus described in Embodiment 5. As the information aggregation apparatuses have been described in detail in embodiments 4 and 5, the contents of which are incorporated herein.

In this embodiment, the first device 1601 is, for example, the server 104 shown in FIG. 1, and the second device is, for example, the network access device 102 or the terminal device 101 shown in FIG. 1; however, this embodiment is not limited thereto.

An embodiment of the present disclosure further provides a computer readable program code, which, when executed in a network device, will cause the network device to carry out the method(s) as described in Embodiment 1 and/or Embodiment 2 and/or Embodiment 3.

An embodiment of the present disclosure further provides a computer readable medium, including a computer readable program code, which will cause a network device to carry out the method(s) as described in Embodiment 1 and/or Embodiment 2 and/or Embodiment 3.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

For implementations of the present disclosure containing the above embodiments, following supplements are further disclosed.

Supplement 1. An information aggregation apparatus, configured in a requestor for information in an information aggregation system, the information aggregation apparatus including:

a generating unit configured to generate an aggregation request, the aggregation request including a source address, a destination address, a requested target device, requested information, and a requested aggregation action; wherein, the source address is an address of the requestor, and the destination address is an address of a receiver, there existing a security relationship between the requestor and the receiver;

an encrypting unit configured to encrypt the aggregation request according to the security relationship between the requestor and the receiver; and

a first processing unit configured to transmit the encrypted aggregation request to the receiver, and record the aggregation request in a request list.

Supplement 2. The apparatus according to supplement 1, wherein the apparatus further includes:

a negotiating unit configured to establish a security relationship with other devices in the information aggregation system, including registering on each other for supporting information aggregation, indicating each other supported information aggregation actions, authenticating, negotiating encryption algorithm, and exchanging keys necessary for the encryption.

Supplement 3. The apparatus according to supplement 2, wherein the information aggregation actions includes any one of the following or a combination thereof:

tailoring;

abstraction;

isolation; and

integration.

Supplement 4. The apparatus according to supplement 1, wherein the number of the requested target device is one, and the receiver is the target device, or the receiver is an intermediate device having established a security relationship with the target device.

Supplement 5. The apparatus according to supplement 1, wherein the number of the requested target device is multiple, and the destination address is a unicast address or a multicast address;

for the unicast address, the receiver is an intermediate device in the same security group as the multiple target devices, and the receiver has established a security relationship with the requestor;

and for the multicast address, the receiver is multiple, and the multiple receivers are the multiple target devices, or the multiple receivers have established a security relationship with the multiple target devices.

Supplement 6. The apparatus according to supplement 5, wherein the aggregation request contains requested information and requested aggregation actions corresponding to the requested target devices.

Supplement 7. The apparatus according to supplement 1, wherein the apparatus further includes:

a receiving unit configured to receive an aggregation reply;

a decrypting unit configured to decrypt the aggregation reply; and

a second processing unit configured to, when a target device in the aggregation reply is in a request list, delete a corresponding record in the request list, and save prepared information in the aggregation reply.

Supplement 8. The apparatus according to supplement 7, wherein,

when the target device in the aggregation reply is in an aggregation list and a target device indicated by a corresponding record in the aggregation list is the target device in the aggregation reply, the second processing unit processes the prepared information in the aggregation reply, and generates a new aggregation reply, the new aggregation reply including a source address, a destination address, a target device, and processed prepared information; wherein, the source address is the address of the requestor, the destination address is an address of a source indicated by the corresponding record in the aggregation list, and the target device is the target device in the aggregation reply; the encrypting unit encrypts the new aggregation reply according to a security relationship between the requestor and the source indicated by the corresponding record in the aggregation list; and the first processing unit transmits the encrypted new aggregation reply to the source, and deletes the corresponding record in the aggregation list.

Supplement 9. The apparatus according to supplement 7, wherein,

when the target device in the aggregation reply is in an aggregation list and the target device indicated by the corresponding record in the aggregation list is multiple target devices containing the target device in the aggregation reply, the second processing unit saves the prepared information in the aggregation reply, waits for aggregation replies fed back by other target devices, processes prepared information in all the aggregation relies, and generates a new aggregation reply, the new aggregation reply including a source address, a destination address, a target device, and processed prepared information; wherein, the source address is the address of the requestor, the destination address is an address of a source indicated by the corresponding record in the aggregation list, and the target device is the multiple target devices; the encrypting unit encrypts the new aggregation reply according to a security relationship between the requestor and the source indicated by the corresponding record in the aggregation list; and the first processing unit transmits the encrypted new aggregation reply to the source, and deletes the corresponding record in the aggregation list.

Supplement 10. The apparatus according to supplement 9, wherein the processing is an isolation action, or an isolation action and other aggregation actions indicated by the corresponding record in the aggregation list.

Supplement 11. The apparatus according to supplement 8, wherein the processing is an isolation action, or an isolation action and other aggregation actions indicated by the corresponding record in the aggregation list.

Supplement 12. An information aggregation apparatus, configured in a receiver receiving an aggregation request in an information aggregation system, the apparatus including:

a receiving unit configured to receive an aggregation request;

a decrypting unit configured to decrypt the aggregation request;

a first processing unit configured to, when the receiver is a target device of the aggregation request, prepare requested information, perform an aggregation action indicated by the aggregation request on the prepared information, and generate an aggregation reply, the aggregation reply including a source address, a destination address, a requested target device, and prepared requested information; wherein, the source address is an address of the receiver, the destination address is an address of a device transmitting the aggregation request, and the requested target device is the receiver;

an encrypting unit configured to encrypt the aggregation reply according to a security relationship between the receiver and the device transmitting the aggregation request; and

a second processing unit configured to transmit the encrypted aggregation reply to the device transmitting the aggregation request.

Supplement 13. The apparatus according to supplement 12, wherein,

when the receiver is not the target device of the aggregation request and there exists a security relationship between the receiver and the target device of the aggregation request, the first processing unit records the aggregation request in an aggregation list, and generates a new aggregation request, the new aggregation request including a source address, a destination address, a requested target device, requested information, and a requested aggregation action; wherein, the source address is an address of the receiver, the destination address is an address of the target device or a multicast address containing at least one target device in the same security group as the receiver; the encrypting unit encrypts the new aggregation request according to a security relationship between the receiver and the target device; and the second processing unit transmits the encrypted new aggregation request to the target device.

Supplement 14. The apparatus according to supplement 12, wherein,

the apparatus further includes:

a negotiating unit configured to establish a security relationship with other devices in the information aggregation system, including registering on each other for supporting information aggregation, indicating each other supported information aggregation actions, authenticating, negotiating encryption algorithm, and exchanging keys necessary for the encryption.

Supplement 15. The apparatus according to supplement 14, wherein the information aggregation actions includes any one of the following or a combination thereof:

tailoring;

abstraction;

isolation; and

integration.

Supplement 16. The apparatus according to supplement 12, wherein,

the receiving unit further receives an aggregation reply;

the decrypting unit further decrypts the aggregation reply;

when a target device in the aggregation reply is in a request list, the first processing unit deletes a corresponding record in the request list, and saves prepared information in the aggregation reply.

Supplement 17. The apparatus according to supplement 16, wherein,

when the target device in the aggregation reply is in an aggregation list and a target device indicated by a corresponding record in the aggregation list is the target device in the aggregation reply, the first processing unit processes prepared information in the aggregation reply, and generates a new aggregation reply, the new aggregation reply including a source address, a destination address, a target device, and processed prepared information; wherein, the source address is an address of the receiver, the destination address is an address of a source indicated by the corresponding record in the aggregation list, and the target device is the target device in the aggregation reply; the encrypting unit encrypts the new aggregation reply according to a security relationship between the receiver and the source indicated by the corresponding record in the aggregation list; and the second processing unit transmits the encrypted new aggregation reply to the source, and deletes the corresponding record in the aggregation list.

Supplement 18. The apparatus according to supplement 16, wherein,

when the target device in the aggregation reply is in an aggregation list and the target device indicated by the corresponding record in the aggregation list is multiple target devices containing the target device in the aggregation reply, the first processing unit saves the prepared information in the aggregation reply, waits for aggregation replies fed back by other target devices, processes prepared information in all aggregation replies, and generates a new aggregation reply, the new aggregation reply including a source address, a destination address, a target device, and processed prepared information; wherein, the source address is an address of the receiver, the destination address is an address of a source indicated by the corresponding record in the aggregation list, and the target device is the multiple target devices; the encrypting unit encrypts the new aggregation reply according to a security relationship between the receiver and the source indicated by the corresponding record in the aggregation list; and the second processing unit transmits the encrypted new aggregation reply to the source, and deletes the corresponding record in the aggregation list.

Supplement 19. The apparatus according to supplement 17, wherein the processing is an isolation action, or an isolation action and other aggregation actions indicated by the corresponding record in the aggregation list.

Supplement 20. The apparatus according to supplement 18, wherein the processing is an isolation action, or an isolation action and other aggregation actions indicated by the corresponding record in the aggregation list.

1. An information aggregation apparatus, configured in a requestor for information in an information aggregation system, the information aggregation apparatus comprising:
a generating unit configured to generate an aggregation request, the aggregation request including a source address, a destination address, a requested target device, requested information, and a requested aggregation action; wherein, the source address is an address of the requestor, and the destination address is an address of a receiver, there existing a security relationship between the requestor and the receiver;
an encrypting unit configured to encrypt the aggregation request according to the security relationship between the requestor and the receiver; and
a first processing unit configured to transmit the encrypted aggregation request to the receiver, and record the aggregation request in a request list.

2. The apparatus according to claim 1, wherein the apparatus further comprises:
a negotiating unit configured to establish a security relationship with other devices in the information aggregation system, including registering on each other for supporting information aggregation, indicating each other supported information aggregation actions, authenticating, negotiating encryption algorithm, and exchanging keys necessary for the encryption.

3. The apparatus according to claim 2, wherein the information aggregation actions comprise any one of the following or a combination thereof:
tailoring;
abstraction;
isolation; and
integration.

4. The apparatus according to claim 1, wherein the number of the requested target device is one, and the receiver is the target device, or the receiver is an intermediate device having established a security relationship with the target device.

5. The apparatus according to claim 1, wherein the number of the requested target device is multiple, and the destination address is a unicast address or a multicast address;
for the unicast address, the receiver is an intermediate device in the same security group as the multiple target devices, and the receiver has established a security relationship with the requestor;
and for the multicast address, the receiver is multiple, and the multiple receivers are the multiple target devices, or the multiple receivers have established a security relationship with the multiple target devices.

6. The apparatus according to claim 5, wherein the aggregation request contains requested information and requested aggregation actions corresponding to the requested target devices.

7. The apparatus according to claim 1, wherein the apparatus further comprises:
a receiving unit configured to receive an aggregation reply;
a decrypting unit configured to decrypt the aggregation reply; and
a second processing unit configured to, when a target device in the aggregation reply is in a request list, delete a corresponding record in the request list, and save prepared information in the aggregation reply.

8. The apparatus according to claim 7, wherein,
when the target device in the aggregation reply is in an aggregation list and a target device indicated by a corresponding record in the aggregation list is the target device in the aggregation reply, the second processing unit processes the prepared information in the aggregation reply, and generates a new aggregation reply, the new aggregation reply including a source address, a destination address, a target device, and processed prepared information; wherein, the source address is the address of the requestor, the destination address is an address of a source indicated by the corresponding record in the aggregation list, and the target device is the target device in the aggregation reply; the encrypting unit encrypts the new aggregation reply according to a security relationship between the requestor and the source indicated by the corresponding record in the aggregation list; and the first processing unit transmits the encrypted new aggregation reply to the source, and deletes the corresponding record in the aggregation list.

9. The apparatus according to claim 7, wherein,
when the target device in the aggregation reply is in an aggregation list and the target device indicated by the corresponding record in the aggregation list is multiple target devices containing the target device in the aggregation reply, the second processing unit saves the prepared information in the aggregation reply, waits for aggregation replies fed back by other target devices, processes prepared information in all the aggregation relies, and generates a new aggregation reply, the new aggregation reply including a source address, a destination address, a target device, and processed prepared information; wherein, the source address is the address of the requestor, the destination address is an address of a source indicated by the corresponding record in the aggregation list, and the target device is the multiple target devices; the encrypting unit encrypts the new aggregation reply according to a security relationship between the requestor and the source indicated by the corresponding record in the aggregation list; and the first processing unit transmits the encrypted new aggregation reply to the source, and deletes the corresponding record in the aggregation list.

10. The apparatus according to claim 9, wherein the processing is an isolation action, or an isolation action and other aggregation actions indicated by the corresponding record in the aggregation list.

11. The apparatus according to claim 8, wherein the processing is an isolation action, or an isolation action and other aggregation actions indicated by the corresponding record in the aggregation list.

12. An information aggregation apparatus, configured in a receiver receiving an aggregation request in an information aggregation system, the apparatus comprising:
a receiving unit configured to receive an aggregation request;
a decrypting unit configured to decrypt the aggregation request;
a first processing unit configured to, when the receiver is a target device of the aggregation request, prepare requested information, perform an aggregation action indicated by the aggregation request on the prepared information, and generate an aggregation reply, the aggregation reply including a source address, a destination address, a requested target device, and prepared requested information; wherein, the source address is an address of the receiver, the destination address is an address of a device transmitting the aggregation request, and the requested target device is the receiver;
an encrypting unit configured to encrypt the aggregation reply according to a security relationship between the receiver and the device transmitting the aggregation request; and
a second processing unit configured to transmit the encrypted aggregation reply to the device transmitting the aggregation request.

13. The apparatus according to claim 12, wherein,
when the receiver is not the target device of the aggregation request and there exists a security relationship between the receiver and the target device of the aggregation request, the first processing unit records the aggregation request in an aggregation list, and generates a new aggregation request, the new aggregation request including a source address, a destination address, a requested target device, requested information, and a requested aggregation action; wherein, the source address is an address of the receiver, the destination address is an address of the target device or a multicast address containing at least one target device in the same security group as the receiver; the encrypting unit encrypts the new aggregation request according to a security relationship between the receiver and the target device; and the second processing unit transmits the encrypted new aggregation request to the target device.

14. The apparatus according to claim 12, wherein,
the apparatus further includes:
a negotiating unit configured to establish a security relationship with other devices in the information aggregation system, including registering on each other for supporting information aggregation, indicating each other supported information aggregation actions, authenticating, negotiating encryption algorithm, and exchanging keys necessary for the encryption.

15. The apparatus according to claim 14, wherein the information aggregation actions comprise any one of the following or a combination thereof:
tailoring;
abstraction;
isolation; and
integration.

16. The apparatus according to claim 12, wherein,
the receiving unit further receives an aggregation reply;
the decrypting unit further decrypts the aggregation reply;
when a target device in the aggregation reply is in a request list, the first processing unit deletes a corresponding record in the request list, and saves prepared information in the aggregation reply.

17. The apparatus according to claim 16, wherein,
when the target device in the aggregation reply is in an aggregation list and a target device indicated by a corresponding record in the aggregation list is the target device in the aggregation reply, the first processing unit processes prepared information in the aggregation reply, and generates a new aggregation reply, the new aggregation reply including a source address, a destination address, a target device, and processed prepared information; wherein, the source address is an address of the receiver, the destination address is an address of a source indicated by the corresponding record in the aggregation list, and the target device is the target device in the aggregation reply; the encrypting unit encrypts the new aggregation reply according to a security relationship between the receiver and the source indicated by the corresponding record in the aggregation list; and the second processing unit transmits the encrypted new aggregation reply to the source, and deletes the corresponding record in the aggregation list.

18. The apparatus according to claim 16, wherein,
when the target device in the aggregation reply is in an aggregation list and the target device indicated by the corresponding record in the aggregation list is multiple target devices containing the target device in the aggregation reply, the first processing unit saves the prepared information in the aggregation reply, waits for aggregation replies fed back by other target devices, processes prepared information in all aggregation replies, and generates a new aggregation reply, the new aggregation reply including a source address, a destination address, a target device, and processed prepared information; wherein, the source address is an address of the receiver, the destination address is an address of a source indicated by the corresponding record in the aggregation list, and the target device is the multiple target devices; the encrypting unit encrypts the new aggregation reply according to a security relationship between the receiver and the source indicated by the corresponding record in the aggregation list; and the second processing unit transmits the encrypted new aggregation reply to the source, and deletes the corresponding record in the aggregation list.

19. The apparatus according to claim 17, wherein the processing is an isolation action, or an isolation action and other aggregation actions indicated by the corresponding record in the aggregation list.

20. The apparatus according to claim 18, wherein the processing is an isolation action, or an isolation action and other aggregation actions indicated by the corresponding record in the aggregation list.
